(19) United States
(12) Patent Application Publication
(10) Pub. No.: US 2013/0106390 A1
(43) Pub. Date: May 2, 2013

(54) CURVATURE-COMPENSATED BAND-GAP VOLTAGE REFERENCE CIRCUIT

(71) Applicant: Sameer Wadhwa, San Diego, CA (US)

(72) Inventor: Sameer Wadhwa, San Diego, CA (US)

(73) Assignee: QUALCOMM Incorporated, San Diego, CA (US)

(21) Appl. No.: 13/286,258

(22) Filed: Nov. 1, 2011

(51) Int. Cl. G05F 3/02; G06F 17/30

(52) U.S. Cl. 323/313; 707/756; 707/E17.001

(57) ABSTRACT

A curvature-compensated band-gap voltage reference circuit includes an operational amplifier and a high-frequency gain stage coupled to an output of the operational amplifier. The circuit also includes an electronic device and a matching circuit.

### I. FIELD

The present disclosure is generally related, to a curvature-compensated band-gap voltage reference circuit.

### II. DESCRIPTION OF RELATED ART

Temperature variations may cause variation in electrical properties of electronic devices. Accordingly, devices may use a bandgap circuit to generate a reference voltage that does not substantially vary with temperature. For example, a “linear” bandgap circuit may combine a proportional to absolute temperature (PTAT) voltage and a complementary to absolute temperature (CTAT) voltage to generate a substantially temperature-independent reference voltage. The “linear” bandgap circuit may be subject to non-linear effects due to temperature changes. A “nonlinear” bandgap circuit may be used to further cancel an additional non-linear voltage caused by thermal noise (e.g., a voltage that is proportional to a logarithm of the temperature). However, the nonlinear bandgap circuit may not be sufficiently accurate in some contexts. For example, canceling a log-term voltage may introduce an additional temperature-dependent steady-state voltage to the reference voltage, reducing the accuracy of the bandgap circuit. The nonlinear bandgap circuit may also utilize a multiple-stage, large-gain, operational amplifier (op amp) that may be difficult to implement or to stabilize (e.g. the multiple-stage op amp may introduce additional dominant poles to the frequency response of the circuit).

### III. SUMMARY

A bandgap circuit in accordance with the present disclosure is configured to cancel a non-linear, temperature-dependent voltage that varies with a natural logarithm of a temperature of the bandgap circuit without introducing additional steady-state voltage errors.

In a particular embodiment, the circuit includes an electronic device that has an electrical property that is dependent on temperature. The circuit also includes a matching circuit that reduces a non-linear effect of a temperature change on a base emitter voltage of the electronic device. The matching circuit equalizes a voltage of the electronic device with a second voltage of a second electronic device when the temperature approaches or is at a reference temperature.

In another particular embodiment, the circuit includes an operational amplifier and a high-frequency gain stage coupled to an output of the operational amplifier.

In another particular embodiment, a circuit includes a first path, a second path, and a third path. The first path includes a first transistor and a first resistor. The second path includes a second transistor, a second resistor, and a third resistor. The third path includes a third transistor. The circuit also includes an operational amplifier having a first input coupled to the first path and a second input coupled to the second path. A node of the first path is coupled to a node of the third path via a fourth resistor. A node of the second path is coupled to the node of the third path via a fifth resistor. The first resistor has a first terminal coupled to the first input of the operational amplifier and a second terminal coupled to the node of the first path.

The bandgap circuit is configured to cancel or substantially cancel a non-linear, temperature-dependent voltage that varies with a natural logarithm of a temperature of the bandgap circuit without introducing additional steady-state voltage errors. For example, feedback resistors may be sized to cancel out or substantially cancel out a temperature-dependent voltage.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative embodiment of a curvature-compensated band gap voltage reference circuit;

FIG. 2 is a block diagram of a portable device including a curvature-compensated band gap voltage reference circuit; and

FIG. 3 is a data flow diagram of a particular illustrative embodiment of a manufacturing process to manufacture electronic devices that include a curvature-compensated band gap voltage reference circuit.

### V. DETAILED DESCRIPTION

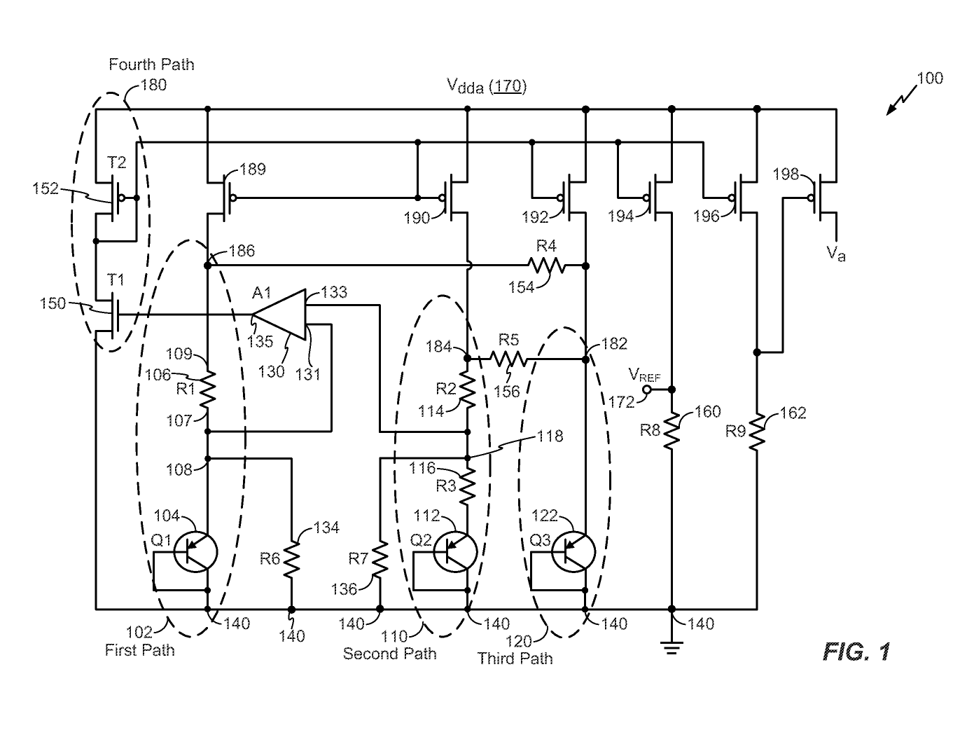

Referring to FIG. 1, a particular illustrative embodiment of a bandgap circuit 100 is shown. The bandgap circuit 100 includes a first path 102, a second path 110, a third path 120, and a fourth path 180. The first path 102 includes a first transistor 104 (Q1) and a first resistor 106 (R1). The second path 110 includes a second transistor 112 (Q2), a second resistor 114 (R2), and a third resistor 116 (R3). The second transistor 112 (Q2) has a second base emitter area that is larger than the first base emitter area of the first transistor 104 (Q1). The circuit 100 also includes a third path 120 including a third transistor 122 (Q3). The third transistor 122 (Q3) has a third base emitter area that is substantially equal to the first base emitter area.

The circuit 100 also includes an operational amplifier 130. The operational amplifier 130 has a first input 131 coupled to the first path 102 and a second input 133 coupled to the second path 110. The first path 102 also includes a node 186 coupled between the first resistor 106 (R1) and a transistor 189 which is coupled to a voltage supply 170 (Vdda). The node 186 of the first path 102 is coupled to a node 182 of the third path 120 by a fourth resistor 154 (R4). A node 184 of the second path 110 is coupled to the node 182 of the third path 120 by a fifth resistor 156 (R5).

The first resistor 106 (R1) of the first path 102 has a first terminal 107 and a second terminal 109. The first terminal 107 is coupled to the node 108 which is coupled to the first input 131 of the operational amplifier 130 (A1). The second terminal 109 of the first resistor 106 is coupled to the node 186 of the first path 102.

A fourth path 180 of the circuit 100 includes a gain transistor 150 (T1) and a mirror transistor 152 (T2). The fourth path 180 is coupled to an output 135 of the operational amplifier 130 (A1). The fourth path 180 is also coupled to the voltage supply 170 (Vdda). In a particular embodiment, a first transconductance of the gain transistor 150 (T1) is greater than a second transconductance of the mirror transistor 152 (T2). The fourth path 180 has a gain that is determined by a ratio of the first transconductance to the second transconductance. In a particular embodiment, the fourth path 180 includes an operational transconductance amplifier that is formed by the gain transistor 150 (T1) and the mirror transistor 152 (T2), as illustrated.

In a particular embodiment, the first transistor 104 (Q1), the second transistor 112 (Q2), and the third transistor 122 (Q3) are diode-configured bipolar transistors.

The intermediated node 108 of the first path 102 is coupled via a sixth resistor 134 (R6) to a ground node 140. An internal node 118 of the second path 110 is coupled to ground 140 via a fifth resistor 136 (R5). The internal node 118 is coupled between the second resistor 114 (R2) and the third resistor 116 (R3). The second resistor 114 (R2) is coupled via the node 184 to a pull up transistor 190 which is coupled to the voltage supply 170.

The third path 120 includes anode 182 which is coupled to a pull up transistor 192 (which is coupled to the voltage supply 170). Additional pull up transistors 194 and 196 are coupled to the voltage supply 170. The transistor 194 is coupled via a reference node 172 to an eighth resistor 160 (R8). The resistor 160 (R8) is coupled to ground 140. The transistor 196 is coupled to anode 197 to a ninth resistor 162 (R9). The resistor 162 (R9) is also coupled to ground 140. The node 197 is coupled to a gate of a transistor 198 which is coupled to the voltage supply 170. The transistor 198 is also coupled to the voltage (Va).

The bandgap circuit 100 is configured to cancel a non-linear, temperature-dependent voltage that varies with a natural logarithm of a temperature of the bandgap circuit 100. The bandgap circuit 100 is further configured to generate, via the first resistor 106 (R1) and the second resistor 114 (R2), a feedback voltage that is substantially equal to a steady-state voltage associated with the third transistor 122 (Q3) at nominal operating temperature. The output of the bandgap circuit 100 provides a temperature-independent reference voltage 172. The temperature-independent reference voltage is substantially independent of the steady-state voltaize.

The circuit 100 includes an operational amplifier and a high-frequency gains stage coupled to an output of the operational amplifier. For example, the operational amplifier 130 (A1) has an output 135 that is coupled to a high-frequency gain stage of the transistors 150 (T1) and 152 (T2) of the fourth path 180. The transistors 150 (T1) and 152 (T2) (i.e. high-frequency gain stage) are coupled to the output 135 of the operational amplifier 130 (A1). In a particular embodiment, the high-frequency gain stage has a pole that is at a frequency higher than a frequency of a dominant pole of the operational amplifier 130 (A1), increasing stability of the circuit 100. The operational amplifier 130 (A1) and the high-frequency gain stage may be incorporated within a bandgap reference circuit, such as the bandgap reference circuit 100. Alternatively, the operational amplifier and the high-frequency gain stage may be incorporated into other circuits.

In operation, the bandgap circuit 100 may generate PTAT currents across the first transistor 104 (Q1) and across the second transistor 112 (Q2). The PTAT currents may be mirrored through the third transistor 122 (Q3), generating a temperature-independent reference voltage 172 (Vref). However, if the third transistor 122 (Q3) carries more current than the first transistor 104 (Q1) and the second transistor 112 (Q2), an additional steady-state voltage error may be present at the third transistor 122 (Q3), reducing accuracy of the reference voltage 172 (Vref). During operation, a first voltage from the first path 102 is received at a first input 131 of the operational amplifier 130 (A1). A second voltage from the second path 110 is received at a second input 133 of the operational amplifier 130 (A1). The operational amplifier 130 (A1) substantially equalizes the first voltage received at the first input 131 and the second voltage received at the second input 133. By equalizing the first voltage of the first path 102 and the second voltage of the second path 110, equal current flows through the resistors R6, R7. Further, a CTAT current flows through the resistors R6, R7, and a PTAT current flows through the first transistor 104 (Q1) and the second transistor 112 (Q2). As a result, a combination of PTAT and CTAT current flows through the first path 102 and the second path 110. The resulting current is first-order temperature independent and is mirrored as first-order temperature independent current that flows through the third transistor 122 (Q3).

However, there is an additional non-linear current term in the devices with CTAT current that varies with the natural log of temperature. This non-linear term can be removed by injecting a current proportional to the difference of voltages across two transistors that carry a PTAT and a constant current. In the bandgap circuit 100, this is accomplished by the resistor network of the resistors 106 (R1), 114 (R2), 154 (R4), and 156 (R5). The magnitude of current flowing through the third transistor 122 (Q3) is not the same as the current flowing through the first and second transistors 104 (Q1), 112 (Q2). This results in a voltage offset between the node 182 and the nodes 108, 118. The resistor network of the resistors 106 (R1) and 114 (R2) is sized to cancel this fixed offset at steady state operating temperature while the resistor network of the resistors 154 (R4) and 156 (R5) delivers a current proportional to the natural log of temperature so as to substantially cancel the non-linear term in the CTAT component of the current in the first path 102 and the second path 110. The resulting current in the devices 152, 189, 190, 192, 194 etc. is substantially independent of temperature.

In a particular embodiment, the first transistor 104 (Q1) is a representative electronic device. A matching circuit equalizes the voltage of the electronic device (e.g. the first transistor 104 (Q1)) with a second voltage of a second electronic device (e.g. the second transistor 112 (Q2)) when the temperature approaches or is at a reference temperature. The first transistor 104 (Q1) and the second transistor 112 (Q2) may each be bipolar transistors as shown. In another embodiment, the transistors may be other types. The matching circuit may include a plurality of resistors. For example, the bandgap circuit 100 includes a plurality of resistors that may be used in connection with various feedback paths to perform the matching circuit functionality. The matching circuit of the bandgap reference circuit 100 may reduce nonlinear effects of an electrical property of an electronic device such as a voltage or current as described. For example, a first base emitter voltage of the first transistor 104 (Q1) substantially matches a second base emitter voltage of the second transistor 112 (Q2) plus the voltage across the third resistor 116 (R3) due to the matching circuit including the other components of the bandgap reference circuit 100. The matching circuit may equalize a current through the first electronic device (e.g. the first transistor 104 (Q1)) with a second current through the second electronic device (e.g. the second transistor 112 (Q2)) when the temperature approaches or is at a desired reference temperature.

During operation, the bandgap circuit 100 may generate PTAT currents across the first transistor 104 (Q1) and across the second transistor 112 (Q2). The PTAT currents combine with the CTAT currents flowing through the resistors 131 (R6) and 136 (R7) to produce a substantially temperature independent current that flows through the devices 189, 190. This current may be mirrored through the third transistor 122 (Q3), generating a temperature-independent reference voltage 172 (Vref). However, if the third transistor 122 (Q3) carries more current than the first transistor 104 (Q1) and the second transistor 112 (Q2), an additional steady-stage voltage error may be present at the third transistor 122 (Q3), thereby reducing accuracy of the reference voltage 172 (Vref). To address this potential issue, the first resistor 106 (R1) and the second resistor 114 (R2) may provide feedback voltages equal to the steady-state voltage error in order to match the steady-state voltage error across the third transistor 122 (Q3). Accordingly, the reference voltage 172 (Vref) will be independent or substantially independent of the steady-state voltage error and may therefore provide a more accurate reference voltage.

The bandgap circuit 100 may further cancel or substantially cancel the temperature-dependent, log-term voltage without using a multi-stage, large-gain operational amplifier. For example, the circuit 100 illustrates a gain transistor 150 (T1) coupled to an output 135 of the operational amplifier 130 (A1). The mirror transistor 152 (T2) may be coupled to the gain transistor 150 (T1) as shown. A transconductance gum of the gain transistor 150 (T1) is greater than a transconductance gₘₚ of the mirror transistor 152 (T2), resulting in a gain of (gₘₙ/gₘₚ) at the output 135 of the operational amplifier 130. Amplifying signals at the output 135 of the operational amplifier 130 using the gain transistor 150 (T1) and the mirror transistor 152 (T2) (i.e. using an operational transconductance amplifier) allows the operational amplifier 130 to be smaller and to have fewer stages. Thus, it will be appreciated that the bandgap circuit 100 depicts a circuit that includes an operational amplifier (e.g. the operational amplifier 130) and a high-frequency gain stage (e.g. the operational transconductance amplifier formed by the gain transistor 150 (T1) and the mirror transistor 152 (T2)) coupled to an output 135 of the operational amplifier 130.

In addition, the circuit 100 includes an electronic device (e.g. the bipolar transistor 104 (Q1)) that has an electrical property that is dependent on temperature (e.g. the first transistor 104 (Q1) has a voltage that varies with temperature). A matching circuit (e.g. a resistor network) reduces a non-linear effect of a temperature change on a base emitter voltage of the electronic device. For example, a matching circuit that includes the resistors 106 (R1), 114 (R2), and 116 (R3) reduces a non-linear effect of a temperature change on abuse emitter voltage of the electronic device (e.g. the first bipolar transistor 104).

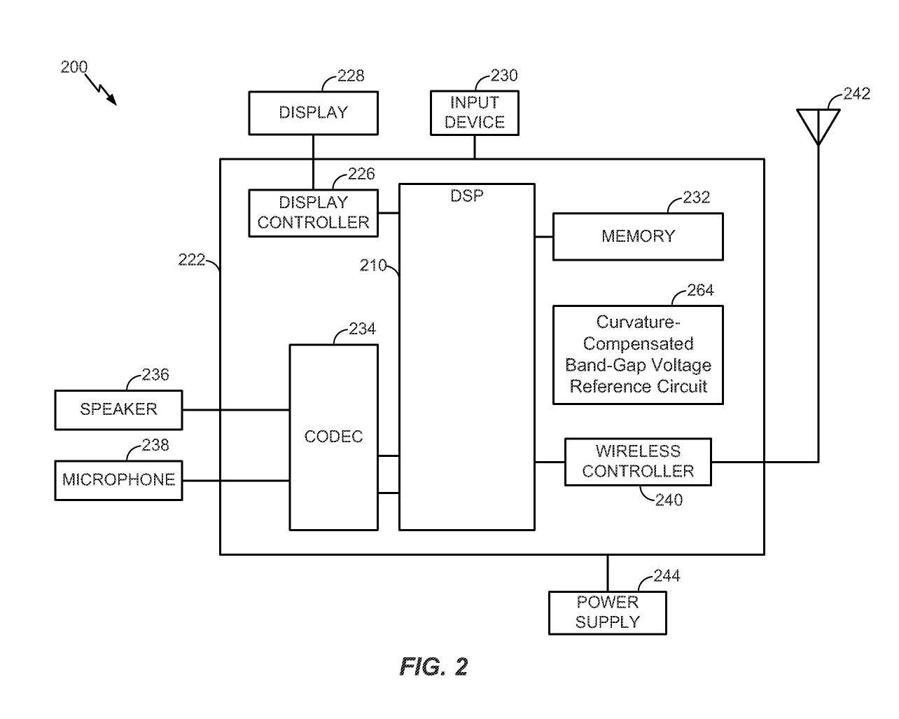

Referring to FIG. 2, a block diagram of a particular illustrative embodiment of an electronic device including a curvature-compensated band-gap voltage reference circuit 264 is depicted and generally designated 200. The device 200 includes a processor, such as a digital signal processor (DSP) 210, coupled to a memory 232, and the device 200 includes the curvature-compensated band-gap voltage reference circuit 264. In an illustrative example, the curvature-compensated band-gap voltage reference circuit 264 includes the bandgap circuit 100 depicted in FIG. 1.

FIG. 2 also shows a display controller 226 that is coupled to the digital signal processor 210 and to a display 228. A coder/decoder (CODEC) 234 can also be coupled to the digital signal processor 210. A speaker 236 and a microphone 238 can be coupled to the CODEC 234.

FIG. 2 also indicates that a wireless controller 240 can be coupled to the digital signal processor 210 and to a wireless antenna 242. In a particular embodiment, the DSP 210, the display controller 226, the memory 232, the CODEC 234, the wireless controller 240, and the curvature-compensated band-gap voltage reference circuit 264 are included in a system-in-package or system-on-chip device 222. In a particular embodiment, an input device 230 and a power supply 244 are coupled to the system-on-chip device 222. Moreover, in a particular embodiment, as illustrated in FIG. 2, the display 228, the input device 230, the speaker 236, the microphone 238, the wireless antenna 242, and the power supply 244 are external to the system-on-chip device 222. However, each of the display 228, the input device 230, the speaker 236, the microphone 238, the wireless antenna 242, and the power supply 244 can be coupled to a component of the system-on-chip device 222, such as an interface or a controller.

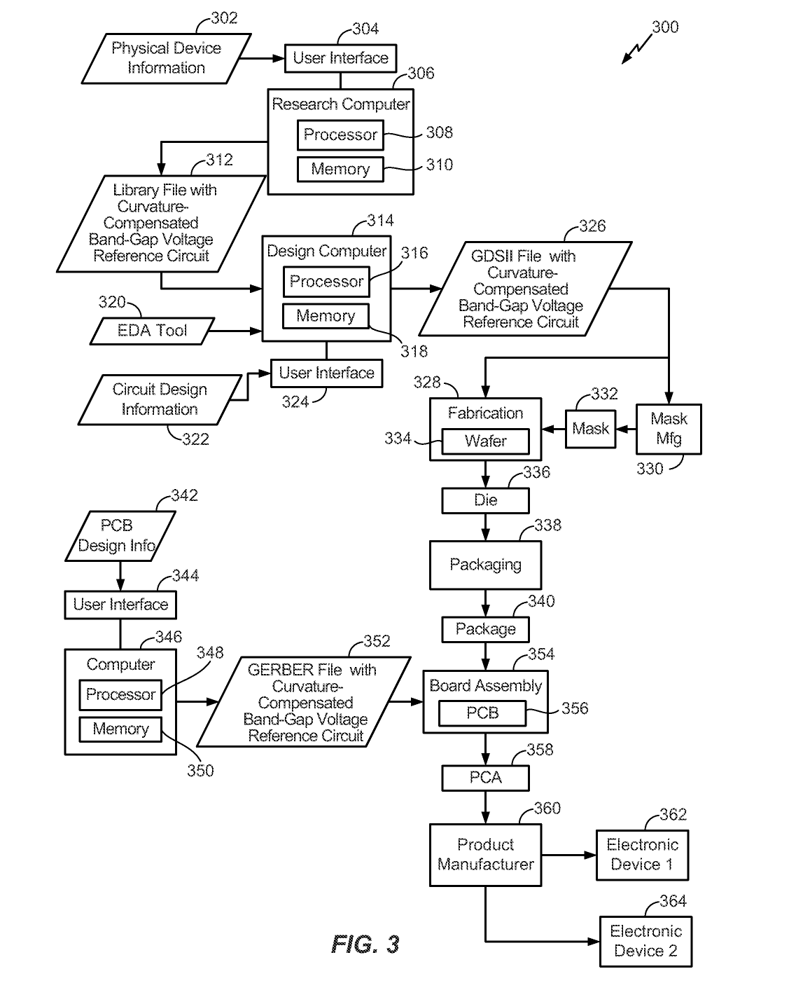

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. The chips are then employed in devices described above. FIG. 3 depicts a particular illustrative embodiment of an electronic device manufacturing process 300.

Physical device information 302 is received in the manufacturing process 300, such as at a research computer 306. The physical device information 302 may include design information representing at least one physical property of a semiconductor device, such as the bandgap circuit 100 of FIG. 1, the curvature-compensated band-gap reference voltage circuit 264 of FIG. 2, or any combination thereof. For example, the physical device information 302 may include physical parameters, material characteristics, and structure information that is entered via a user interface 304 coupled to the research computer 306. The research computer 306 includes a processor 308, such as one or more processing cores, coupled to a computer readable medium such as a memory 310. The memory 310 may store computer readable instructions that are executable to cause the processor 308 to transform the physical device information 302 to comply with a file format and to generate a library file 312.

In a particular embodiment, the library file 312 includes at least one data file including transformed design information. For example, the library file 312 may include a library of semiconductor devices including the bandgap circuit 100 of FIG. 1, the curvature-compensated band-gap reference voltage circuit 264 of FIG. 2, or any combination thereof, that is provided for use with an electronic design automation (EDA) tool 320.

The library file 312 may be used in conjunction with the EDA tool 320 at a design computer 314 including a processor 316, such as one or more processing cores, coupled to a memory 318. The EDA tool 320 may be stored as processor executable instructions at the memory 318 to enable a user of the design computer 314 to design a circuit using the bandgap circuit 100 of FIG. 1, the curvature-compensated band-gap reference voltage circuit 264 of FIG. 2, or any combination thereof, of the library file 312. For example, a user of the design computer 314 may enter circuit design information 322 via a user interface 324 coupled to the design computer 314. The circuit design information 322 may include design information representing at least one physical property of a semiconductor device, such as bandgap circuit 100 of FIG. 1, the curvature-compensated band-gap reference voltage circuit 264 of FIG. 2, or any combination thereof. To illustrate, the circuit design information may include identification of particular circuits and relationships to other elements in a circuit design, positioning information, feature size information, interconnection information, or other information representing a physical property of a semiconductor device.

The design computer 314 may be configured to transform the design information including the circuit design information 322 to comply with a file format. To illustrate, file formation may include a database binary file format representing planar geometric shapes, text labels, and other information about a circuit layout in a hierarchical format, such as a Graphic Data System (GDSII) file format. The design computer 314 may be configured to generate a data file including the transformed design information, such as a GDSII file 326 that includes information describing the bandgap circuit 100 of FIG. 1, the curvature-compensated band-gap reference voltage circuit 264 of FIG. 2, or any combination thereof, in addition to other circuits or information. To illustrate, the data file may include information corresponding to a system-on-chip (SOC) that includes the bandgap circuit 100 of FIG. 1 and that also includes additional electronic circuits and components within the SOC.

The GDSII file 326 may be received at a fabrication process 328 to manufacture the bandgap circuit 100 of FIG. 1, the curvature-compensated band-gap reference voltage circuit 264 of FIG. 2, or any combination thereof, according to transformed information in the GDSII file 326. For example, a device manufacture process may include providing the GDSII file 326 to a mask manufacturer 330 to create one or more masks, such as masks to be used for photolithography processing, illustrated as a representative mask 332. The mask 332 may be used during the fabrication process to generate one or more wafers 334, which may be tested and separated into dies, such as a representative die 336. The die 336 includes a circuit including the bandgap circuit 100 of FIG. 1, the curvature-compensated band-gap reference voltage circuit 264 of FIG. 2, or any combination thereof.

The die 336 may be provided to a packaging process 338 where the die 336 is incorporated into a representative package 340. For example, the package 340 may include the single die 336 or multiple dies, such as a system-in-package (SiP) arrangement. The package 340 may be configured to conform to one or more standards or specifications, such as Joint Electron Device Engineering Council (JEDEC) standards.

Information regarding the package 340 may be distributed, to various product designers, such as via a component library stored at a computer 346. The computer 346 may include a processor 348, such as one or more processing cores, coupled to a memory 3100. A printed circuit board (PCB) tool may be stored as processor executable instructions at the memory 350 to process PCB design information 342 received from a user of the computer 346 via a user interface 344. The PCB design information 342 may include physical positioning information of a packaged semiconductor device on a circuit board, the packaged semiconductor device corresponding to the package 340 including the bandgap circuit 100 of FIG. 1, the curvature-compensated band-gap reference voltage circuit 264 of FIG. 2, or any combination thereof.

The computer 346 may be configured to transform the PCB design information 342 to generate a data file, such as a GERBER file 352 with data that includes physical positioning information of a packaged semiconductor device on a circuit board, as well as layout of electrical connections such as traces and vias, where the packaged semiconductor device corresponds to the package 340 including the bandgap circuit 100 of FIG. 1, the curvature-compensated band-gap reference voltage circuit 264 of FIG. 2, or any combination thereof. In other embodiments, the data file generated by the transformed PCB design information may have a format other than a GERBER format.

The GERBER file 352 may be received at a board assembly process 354 and used to create PCBs, such as a representative PCB 356, manufactured in accordance with the design information stored within the GERBER file 352. For example, the GERBER file 352 may be uploaded to one or more machines for performing various steps of a PCB production process. The PCB 356 may be populated with electronic components including the package 340 to form a represented printed circuit assembly (PCA) 358.

The PCA 358 may be received at a product manufacture process 360 and integrated into one or more electronic devices, such as a first representative electronic device 362 and a second representative electronic device 364. As an illustrative, non-limiting example, the first representative electronic device 362, the second representative electronic device 364, or both, may be selected from the group of a set top box, a music player, a video player, an entertainment unit, a navigation device, a communications device, a personal digital assistant (PDA), a fixed location data unit, and a computer. As another illustrative, non-limiting example, one or more of the electronic devices 362 and 364 may be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although one or more of FIGS. 1-2 may illustrate remote units according to the teachings of the disclosure, the disclosure is not limited to these exemplary illustrated units. Embodiments of the disclosure may be suitably employed in any device that includes integrated circuitry.

Thus, the bandgap circuit 100 of FIG. 1, the curvature-compensated band-gap reference voltage circuit 264 of FIG. 2, or any combination thereof, may be fabricated, processed, and incorporated into an electronic device, as described in the illustrative process 300. One or more aspects of the embodiments disclosed with respect to FIGS. 1-2 may be included at various processing stages, such as within the library file 312, the GDSII file 326, and the GERBER file 352, as well as stored at the memory 310 of the research computer 306, the memory 318 of the design computer 314, the memory 350 of the computer 346, the memory of one or more other computers or processors (not shown) used at the various stages, such as at the board assembly process 354, and also incorporated into one or more other physical embodiments such as the mask 332, the die 336, the package 340, the PCA 358, other products such as prototype circuits or devices (not shown), or any combination thereof. Although various representative stages of production from a physical device design to a final product are depicted, in other embodiments fewer stages may be used or additional stages may be included. Similarly, the process 300 may be performed by a single entity, or by one or more entities performing various stages of the process 300.

Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A circuit, comprising:
a first path including a first transistor and a first resistor;
a second path including a second transistor, a second resistor, and a third resistor;
a third path including a third transistor; and
an operational amplifier having a first input coupled to the first path and a second input coupled to the second path,
wherein a node of the first path is coupled to a node of the third path via a fourth resistor, wherein a node of the second path is coupled to the node of the third path via a fifth resistor, and wherein the first resistor has a first terminal coupled to the first input of the operational amplifier and a second terminal coupled to the node of the first path.

2. The circuit of claim 1, wherein the first path, the second path, the third pa and the operational amplifier are included in a bandgap circuit.

3. The circuit of claim 2, wherein the bandgap circuit is configured to cancel a non-linear, temperature-dependent voltage that varies with a natural logarithm of a temperature of the bandgap circuit.

4. The circuit of claim 3, wherein the bandgap circuit is further configured to generate, via the first resistor and the second resistor, a feedback voltage that is substantially equal to a steady-state voltage associated with the third transistor.

5. The circuit of claim 4, wherein the bandgap circuit includes an output configured to provide a temperature-independent reference voltage, and wherein the temperature-independent reference voltage is substantially independent of the steady-state voltage.

6. The circuit of claim 1, further comprising a fourth path, wherein the fourth path is coupled to an output of the operational amplifier, and wherein the fourth path includes a gain transistor and a mirror transistor.

7. The circuit of claim 6, wherein a first transconductance of the gain transistor is greater than a second transconductance of the mirror transistor, and wherein the fourth path has a gain determined by a ratio of the first transconductance to the second transconductance.

8. The circuit of claim 7, wherein the fourth path includes an operational transconductance amplifier formed by the gain transistor and the mirror transistor.

9. The circuit of claim 1, wherein the first transistor, the second transistor, and the third transistor are diode-configured bipolar transistors.

10. The circuit of claim 1, further comprising again transistor responsive to the operational amplifier.

11. The circuit of claim 1 integrated into at least one semiconductor die.

12. The circuit of claim 1, further comprising a device, selected from the group consisting of a set top box, music player, video player, entertainment unit, navigation device, communications device, personal digital assistant (PDA), fixed location data unit, and a computer, into which the first path, the second path, the third path, and the operational amplifier are integrated.

13. A circuit comprising:
an operational amplifier; and
a high-frequency gain stage coupled to an output of the operational amplifier.

14. The circuit of claim 13, wherein the high-frequency gain stage has a pole that is at a frequency higher than a frequency of a dominant pole of the operational amplifier.

15. The circuit of claim 13, wherein the operational amplifier and the high-frequency gain stage are incorporated within a bandgap reference circuit.

16. The circuit of claim 13, wherein the operational amplifier equalizes a first current and a second current.

17. The circuit of claim 13, wherein the first current is received at a first input of the operational amplifier, and wherein the second current is received at a second input of the operational amplifier.

18. The circuit of claim 13 integrated into a east one semiconductor die.

19. The circuit of claim 13, further comprising a device, selected from the group consisting of a set top box, music player, video player, entertainment unit, navigation device, communications device, personal digital assistant (PDA), fixed location data unit, and a computer, into which the operational amplifier and the high frequency gain stage are integrated.

20. A circuit comprising:
an electronic device that has an electrical property that is dependent on temperature; and
a matching circuit that reduces a non-linear effect of a temperature change on a base emitter voltage of the electronic device,
wherein the matching circuit equalizes voltage of the electronic device with a second voltage of a second electronic device when the temperature approaches or is at a reference temperature.

21. The circuit of claim 20, wherein the electronic device is a bipolar transistor.

22. The circuit of claim 20, wherein the electronic device and the matching circuit are incorporated within a bandgap circuit.

23. The circuit of claim 20, wherein the matching circuit includes multiple resistors.

24. The circuit of claim 20, wherein the electrical property is a voltage or a current.

25. The circuit of claim 20, wherein a first base emitter voltage of the first electronic device matches a second base emitter voltage of a second electronic device.

26. The circuit of claim 25, wherein the matching circuit equalizes a current through the first electronic device with a second current through the second electronic device when the temperature approaches or is at the reference temperature.

27. The circuit of claim 20 integrate into at least one semiconductor die.

28. The circuit of claim 20, further comprising a device, selected from the group consisting of a set top box, music player, video player, entertainment unit, navigation device, communications device, personal digital assistant (PDA), fixed location data unit, and a computer, into which electronic device and the matching circuit are integrated.

29. An apparatus comprising:
first means for amplifying a differential voltage; and
second means for amplifying an output of the first means for amplifying, wherein the second means for amplifying applies a high-frequency gain to the output.

30. The apparatus of claim 29 integrated into at least one semiconductor die.

31. The apparatus of claim 29, further comprising a device, selected from the group consisting of a set top box, music player, video player, entertainment unit, navigation device, communications device, personal digital assistant (PDA), fixed location data unit, and a computer, into which the first means and the second means are integrated.

32. A method comprising:
receiving design information representing at least one physical property of a semiconductor device, the semiconductor device comprising:
an operational amplifier; and
a high-frequency gain stage coupled to an output of the operational amplifier;
transforming the design information to comply with a file format; and
generating a data file including the transformed design information.

33. The method of claim 32, wherein the data file includes a GDSII format.

34. The method of claim 32, wherein the data file includes a GERBER format.

35. A method comprising:
a first step for receiving design information representing at least one physical property of a semiconductor device, the semiconductor device comprising:
an operational amplifier; and
a high-frequency gain stage coupled to an output of the operational amplifier;
a second step for transforming the design information to comply with a file format; and
a third step for generating a data file including the transformed design information.

36. The method of claim 35, wherein the data file includes a GDSII format.

37. The method of claim 35, wherein the data file includes a GERBER format.
